(19) United States
(12) Patent Application Publication
(10) Pub. No.: US 2010/0269920 A1
(43) Pub. Date: Oct. 28, 2010

(54) Methods and apparatuses for complementary pneumatic devices and circuits

(76) Inventor: Albert K. Henning, Palo Alto, CA (US)

Correspondence Address: Albert K. Henning, 199 Heather Lane, Palo Alto, CA, 94303-3002, US

(21) Appl. No.: 12/657,510

(22) Filed: Jan. 22, 2010

Related U.S. Application Data
(60) Provisional application No. 61/205,772, filed on Jan. 22, 2009.

(51) Int. Cl. F16K 31/12; F16K 15/00

(52) U.S. Cl. 137/487.5; 137/511

(57) ABSTRACT

The RABBAT ELECTRIC HYBRID VEHICLES have no mechanical transmission of power, only ductile wires connecting various sections of the car.

The multiplicity of capacitor/battery units makes it easier for the vehicle designer to position them around for cosmetic or actual mechanical need, for better handling and safety.

A diode between the motor and battery ensures that there is never any backflow of current. The ultra-capacitor/battery units which are charged thru a plug-in or a pantograph from an external supply and by an internal engine/generator which could be H2/O2, liquid/gas, internal combustion/jet/rocket/explosive) running at a uniform most efficient rate without being affected by stops or starts, slowing or acceleration, from start to finish.

In this vehicle there is no juggling between application of internal combustion energy and electrical energy. It is sequential: fuel to electricity to motor drive, all the time.

The RABBAT BUS STOP where potential passengers wait for the bus, offers certain services and saves bus time by having customers purchase bus tokens or electronic tickets ahead of the bus arrival. Then they access the bus thru a turnstile. The RABBAT BUS STOP provides grid supplied electricity to the bus as soon as its railings make contact, during its wait, and until its railings lose contact with the external supply.

### BACKGROUND

The car used to be called a horseless carriage because it was driven by a built-in motor instead of being pulled by a beast of burden.

After about a century of being useful, the traditional built-in engine is quickly becoming detrimental to better vehicle design with more modern and more efficient engines. Just as an electric trolley or tram does not carry on board the electric generator supplying it (it could be tens or even hundreds of miles away), in modern so-called hybrid cars the power generator no longer needs to be placed within or close to the passenger cabin or the merchandise box-car of a truck.

Long ago, when the motor of a car was housed in a box, it could be opened on either side for easy access and repairs, as well as from the front for cranking. Then the shape of the car became important because sleekness not only helped efficiency by becoming more aerodynamic but above all by increasing sales because it had more appealing lines. The result was the car engine of the present-day, cramped into a space grudgingly allowed by the designer with wires and ducts criss-crossing to connect various parts of the engine. The present situation is a nightmare for both owners and mechanics who now use expletives at a rate reminiscent of our forefathers cart drivers.

The engines of the future: battery-car, hydrogen-cell car, turbine-car, will never really take-off unless we jettison our preconceptions and allow engineers full latitude to build the most compact engines, irrespective of the form of the cabin. I suggest we give them a tandem that can be accessed from all sides.

Since we live in a world faced with seemingly insoluble environmental problems of energy availability, we do not need just a new engine that is better but also a new transportation system that is more streamlined and more frugal with energy.

The RABBAT ELECTRIC HYBRID VEHICLE is charged through a pantograph and/or a plug-in system (see my Pat. Appl. #US-2008-0229749-A1) for smaller vehicles that do not belong to commercial transport systems. These vehicles can be charged, when not in use, or through overhanging pantographs during stops, while in use, or at terminal stations. Plugging into cheaper electric grids at different cost/availability prices will reduce the overall cost of transportation while enabling grid energy providers to build more efficient supply systems for greater profits to their shareholders and greater and cheaper convenience for their customers. It would improve the environment for mankind by reducing the energy waste of the present system to make possible a greener earth.

The RABBAT ELECTRIC HYBRID VEHICLE will move transportation to offer a better environment by providing modular construction so that only a module need to be replaced at a time, saving both energy and materials that have been produced with further energy inputs.

Generators that work at a constant rate, non-stop, when in use, provide the most efficient use of fuels on board the vehicle and reduce overall fuel consumption in our society.

Plugging-in to community electric grids whenever possible, will prevent the waste of electricity in those grids. These grids are usually supplied from multi-sources such as atomic, hydro-electric, hydrocarbon, solar, chemical.

### SUMMARY OF THE INVENTION

Taking the generator out of the car chassis allows the designer to go for more attractive and more stable configurations. The absence of transaxle and gears allows for cars that would hug the roadbed more closely, a lower center of gravity and greater safety at high speeds or going around corners. There is greater chance that the action of the center of gravity will keep within the base.

It is time to relegate the source of power (including its heat, noise and pollution) to the outside whether it be a generator, an internal combustion engine (using gasoline, gasohol, alcohol or synthetic fuels), a heavy duty battery, a hydrogen cell or engine, or a turbine engine.

Once out of the chassis-shell, the source of energy can take a configuration that is more logical, compact and effective. The cabin will become more spacious, comfortable and ergonomic because design is no more restricted by engine parts and connections. For trucks, the platform will hug the roadbed, affording a low center of gravity. On the long run, new overpasses will be less high and consequently have a shorter gradient. Millions of dollars will be saved to build lower concrete spans, shorter access roads and ramps—reducing expenditures for the Department of Transportation.

We are going to use to its fullest advantage both electric power, its transmission and electronic controls, to free designers and engineers from the straightjacket of physical transmission and let them decentralize power application while concentrating power production.

Since the internal combustion engine is still predominant, we shall apply our ideas to it with the intention that more advanced engines would replace it, including the Rabbat Plug-in Engine, as circumstances permit, as an intrinsic part of this invention.

The vehicle of this invention is made up of two sections:

(a) The ideal cabin,

(b) The ideal attached engine section, or articulated tandem section.

(a) This section contains the steering wheel, the ignition, the accelerator, ventilation and air conditioning system, lighting, both internal and external, music, radio, possibly television and other gadgets (if commercially required) electronic dials and knobs controlling every sensor and every part of the vehicle. Every part of the electric and electronic systems are interfaced at the engine section or the articulation for the tandem section where the power generator is located. The front wheels are only for support and direction, not for drive.

(b) The power drive is made up of the generator(s). It supplies electricity to the electric motors embedded in the wheels.

The RABBAT ELECTRIC HYBRID VEHICLE, may be a car or a van with or without composite articulation, a truck or truck-trailer or a bus or bus-tandem. This set-up enables the construction of the most ergonomically and artistically comfortable carriages, and, on the other hand, the most efficient power units.

The modular set-up is not limited to the engine and chassis and cabin sections. As much as possible, roof, panels electronic systems, ventilation, air-conditioning, front parts, rear parts are built in modules. The modular set-up will enable nations with low-cost manpower to share in this industry according to their technological abilities. The whole world economy will get more balanced thus enabling poorer countries to import modules they cannot build to fit them to the sections that lie within their means of production. This will result in greater international trade with increased trade in finished and partial products for a wealthier mankind.

This invention will use present level technology internal combustion engines in their most efficient form, namely the one-speed electric generator, and will allow for the incorporation of improvements through the replacement of modules without the drastic total change, the waste of time, retooling and delays in new introductions that we see in new models today.

### DESCRIPTION

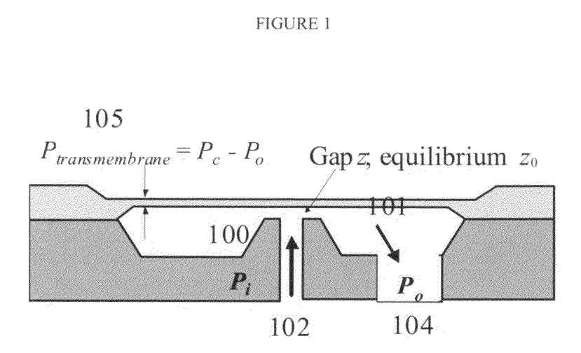

FIG. 1(a) is a lateral view of a RABBAT URBAN ELECTRIC HYBRID BUS. The top of the bus carries two rails (1), a positive one and a negative one, that should make contact with the pantograph at bus-stops or stations for re-energizing the batteries of the vehicle while it is waiting for passengers to disembark or to board. As the bus moves off from the stop/station, it needs a higher amount of electricity to overcome inertia and get rolling. For maximum efficient use of grid electricity, the length-long rails on top keep in contact until the end of the rails move away from the pantograph. On either side of the bus are flaps with locks (2). These cover the banks of batteries hidden under seats along the side-walls. The front wheels (3) are used to partly support the weight of the vehicle and to direct it. The rear wheels (4) support the vehicle and impart motion to it. Electric motors are embedded in these wheels for traction. The module (5) at the back of the vehicle, is the fuel container. It has a filling cap (6) on top for refueling. It also has a hose (7) to provide fuel to the engine module (8) below. This hose can be disconnected whenever either module needs replacement. The engine module (8) can be loaded in position using a special forklift that uses its forks to lift the module thru side hangers (9). When the engine needs repair, it is lifted out and taken to the garage and a replacement engine is fitted in to immediately get the bus on its way without further delay or inconvenience to the passengers. This ability to replace a module raises the efficiency of the transportation grid for greater customer satisfaction and greater time/money savings. The front and rear fenders (10) are made up of pipes. These are bought off the market and do not need to be produced in the bus factory. Whenever a pipe which is part of the fender gets dented in an accident, only that pipe needs to be replaced. Since payment for the ride is effected outside the vehicle, at the bus-stop, the driver is not involved in accuracy of payment. His duty at the stop is concerned with the safety of boarding, helping passengers who need special treatment, and re-energizing the vehicle batteries. The doors (11) need not be close to the driver. They are placed centrally for easier ingress and egress. Because the level of the vehicle is so close to the roadbed, the vehicle does not need any special hydraulics to make the vehicle “kneel” for the convenience of wheel chair passengers. The driver watches the road to the rear and the sides thru closed circuit cameras (12). Using wireless cameras may seem to be the way to go until such cameras become ubiquitous on the roads and the electronic chatter may produce reception problems. The chassis is built on a sturdy platform (13).The platform lies low close to the roadbed for several benefits including having a lower center of gravity for the whole vehicle. At the front where the driver and controls are located, and at the back, the platform rises to a higher level in order to accommodate the wheels. The driver's cabin, with all the necessary instrumentation, is located around the seat of the driver. He has a wide angle view of the front and immediate sides through the front window, and the back and sides through the monitors of the electronic closed-circuit cameras. The tires (14) are ideally each made of a flat reinforced rubber strip circling the wheel rim. Though regular inflated tires can be used, the ideal is to have cheaper flat tires. The suspension system of the wheels should compensate more efficiently for the lack of air chamber within the tires. The rear wheels of the RABBAT URBAN ELECTRIC HYBRID VEHICLE have electric motors (15) embedded in them. They could optionally have the motors directly connected to the wheels. The generator-engine module (16), at the rear of the vehicle has air-diverters on each side to scoop ambient air into the engine compartment for cooling purposes.

FIG. 1(b). The front of the RABBAT URBAN ELECTRIC HYBRID BUS shows the wide panel of the window of the driver's cabin (3) flanked on either side by the electronic cameras (4). Above the front panel of the window lies a strip of powerful LED lights (2) for long beam illumination of the road ahead. Below the front panel of the window is a strip of powerful LED lights (5) with lenses, to illuminate the short distance directly ahead of the bus with a low beam. Above the cabin are the electric rails (1) that make contact with the pantograph of the bus-stop or station for recharging the batteries during the run. The front wheels (6) are used to direct the bus while partially supporting the weight. The fenders (7) are made up of horizontally attached pipes which can individually be replaced in case of need. It is cheaper than replacing a whole fender section as in present-day buses. The use of commonly available pipes will render the cost even lower.

FIG. 1(c) The rear of the RABBAT URBAN ELECTRIC HYBRID shows wide wheels (6) which have electric motors embedded in them to drive the vehicle. On either side there is an electronic camera to send the view to the driver's monitors. Sitting on the raised platform (12) is the engine (11). Above the said engine, on a sturdy support which is an extension of the vehicle's chassis platform, is the fuel tank (2). The fuel tank has a capped fuel intake (3) on top and a connecting hose (5) below, that supplies the engine with fuel. This hose can be disconnected from either end, top or bottom, in order to allow for the removal of either the engine or the fuel tank. The said hose has a flow control to be turned off prior to disconnection in order to prevent spilling of the fuel. The rear of the vehicle has a strip of LED lights (7) which include brake lights and turn signals. The lower part of the vehicle is protected by a set of pipes acting as a fender (9). These are the same type as those of the front of the vehicle and are capable of being replaced individually in case of need. The air intake diverters (1) scoop ambient air driven in by the motion of the vehicle, to cool the generator compartment. The fuel tank (2) is filled through the capped refilling opening (3). The electric rail contacts (4) serve to collect electricity from stop/station pantographs.

FIG. 1(d). Top view of the RABBAT URBAN ELECTRIC HYBRID VEHICLE. The electric rail contacts (1) pick up electricity from the pantograph whenever in contact. The engine module sits under the fuel tank (2) at the rear of the vehicle. The fuel tank has a refill opening with a cap (3).

FIG. 1(e). This is the top view plan of the interior of the RABBAT URBAN ELECTRIC HYBRID BUS. The driver's cubicle (1) has a panel (2) with all the dials controlling the electric and electronic equipment and lighting. It contains closed circuit camera monitors (3) for viewing the surroundings laterally and behind when driving the vehicle. There are steps (6) leading from the driver's cubicle into the passenger area. On the right hand side of the driver's cubicle is the heating and air conditioning unit (7). The driver's seat (8) is adjustable. Behind the passengers cabin and above the rear wheels are the generator module (16) with the generator (13) and the generator motor (15) connected by the axle (14). The passenger cabin has seats (9) on either side covering the spaces where the banks of batteries are located. Space (12) is left for standing passengers and wheelchair attachment. Seats (10) are front facing. Doors (1) allow for ingress and egress. The front one allows for wheelchair entry and exit.

Figure (a). This is a lateral view of the RABBAT ARTICULATED ELECTRIC HYBRID BUS. The top of the bus carries two sets of rails (1), a positive and a negative set, that should make contact with the pantograph. These electric contact rails are divided into two sections, front and aft, which are connected by loose wiring, (17), to allow for movement without disconnecting the flow of current being received from the pantograph. On either side of the bus are flaps with locks (2). These cover the banks of batteries hidden under seats along the side walls. The front set of wheels (3) are used to partly support the weight of the vehicle and to direct it. The second set of wheels (3) do not serve for direction, just for carrying part of the load and keeping it rolling. The two sets of rear wheels (4) support the vehicle and impart motion to it. Electric motors are embedded in these wheels (4) for traction. The module (5) at the back of the vehicle is the fuel container. It has a filling cap (6) on top for refueling. It also has a hose (7) to provide fuel to the engine module (8) below. This hose can be disconnected whenever either module needs replacement. The engine module (8) can be loaded in position using a special forklift to lift the module through side hangers (9). When the engine needs repair, it is lifted out and taken to the garage and a replacement engine is fitted in immediately to get the bus on its way without any further delay or inconvenience to the passengers. The front and rear fenders (10) are made up of pipes. Connecting the front and aft sections of the RABBAT ARTICULATED ELECTRIC HYBRID BUS are accordion-like sides and top (17). They provide enclosure while allowing articulated movement around the turning floor connection. The doors (11) are placed strategically for easier egress and ingress. The driver uses closed circuit cameras (12) to cover his surroundings. The chassis are built on sturdy platforms (13) close to the roadbed. At the front and at the back, the platform rises to accommodate the wheels especially the front turning ones. The driver's cabin and all controls are located at the front of the bus around the driver's seat. The tires (14) are made of a flat reinforced rubber strip circling the wheel rim. The rear wheels have electric motors (15) embedded in them. Each set of drive wheels could alternatively have its centrally-located electric motors in between. The generator-engine module (16) at the rear of the vehicle has air-diverters on each side to scoop ambient air into the engine compartment to cool it.

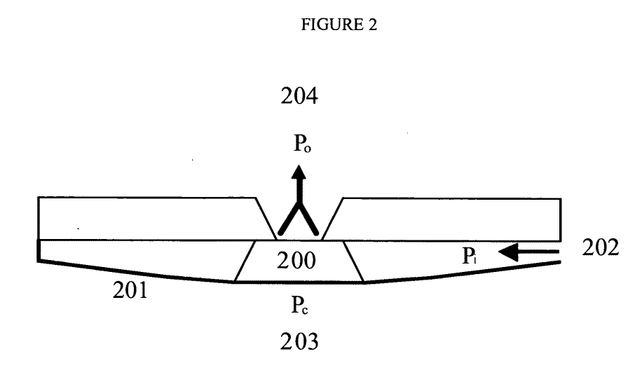

FIG. 2(b). of the RABBAT ARTICULATED ELECTRIC HYBRID BUS the same as FIG. 1(b) of the RABBAT URBAN ELECTRIC HYBRID BUS.

FIG. 2(c) of the RABBAT ARTICULATED ELECTRIC HYBRID BUS is the same as FIG. 1(c) of the RABBAT URBAN ELECTRIC HYBRID BUS.

FIG. 2(d). This is the top view of the RABBAT URBAN ARTICULATED BUS. It is similar to that of the RABBAT URBAN ELECTRIC HYBRID BUS except that, since it is composed of two sections, the railings are connected individually by a loose hanging wire to keep the current flowing whichever section is in contact with the pantograph.

FIG. 2(e). Top view plan of the interior of the RABBAT URBAN ARTICULATED ELECTRIC HYBRID BUS. The driver's cubicle (1) has a panel (2) with all the dials controlling the electric and electronic equipment and lighting. It contains closed circuit camera monitors (3) for viewing the surroundings laterally and behind when driving the vehicle. There are steps (6) leading from the driver's cubicle into the passenger area. On the right hand side of the driver's cubicle is the heating and air conditioning unit (7). The driver's seat (8) is adjustable. Behind the passengers cabin and above the rear wheels are the generator module (16) with the generator (13) and the generator motor (15) connected by the axle (14). The passengers area has seats (9) on either side covering the spaces where the banks of batteries are located. Space (12) is left for standing passengers and wheelchair attachment. Seats (10) are front facing. Doors (11) allow for ingress and egress. The front door allows for wheel chair accessibility.

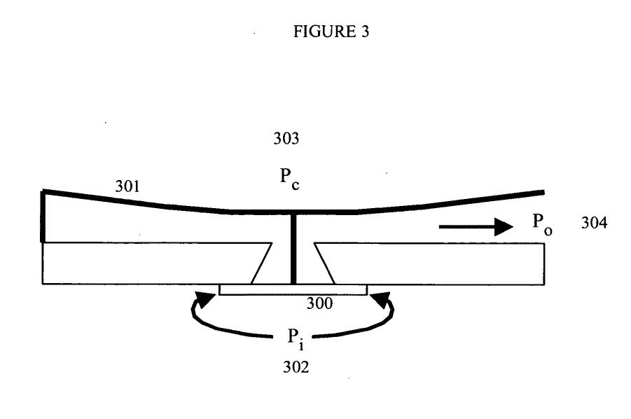

FIG. 3(a). This is the lateral view of the RABBAT INTERURBAN ELECTRIC HYBRID VEHICLE. The top of the bus does not carry any electric rails since this bus does not make frequent stops to collect grid electricity. The bus has an electric self re-winding electric line (1) to connect to the electric grid at its longer stops and terminals. Those stops/terminals have plugs not pantographs. On either side of the bus are flaps with locks (2) covering the banks of batteries which can be rolled out and in. The front set of wheels (3) serve to direct the vehicle and partly support its weight. The two sets of rear wheels (4) support the vehicle and impart motion to it. Electric motors are embedded in these wheels for traction. The module (5) at the back of the vehicle, is the fuel container. It has a filling cap (6) on top for refueling. It also has a hose (7) to provide fuel to the engine module (8) below. The engine module (8) can be loaded and unloaded using a special forklift. The front and rear fenders (10) are made up of pipes. Only a damaged pipe-fender part need to be replaced when damaged. The door (11) is at the front of the passenger cabin. It has a folding set of steps leading down to the street level for easy access. The driver uses wireless cameras (12) connected to cabin monitors to watch the road to the rear and sides. The chassis is built on a sturdy platform (13) close to the roadbed with a space (17) above it and beneath the passenger cabin floor (18). This space is for luggage. The tires (14) are made of a flat reinforced rubber or silicone strip circling the wheel rim. The special suspension system of the wheels should compensate adequately for the lack of air chambers within the tires. The rear wheels of the RABBAT INTERURBAN ELECTRIC HYBRID BUS have electric motors (15) embedded in them. They could optionally have the motors directly connected to the wheels. The generator-engine module (16), at the rear of the vehicle., has air-diverters on each side to scoop ambient air to cool the engine compartment. Unlike urban buses where aerodynamic shape is not important, long-range RABBAT INTERURBAN ELECTRIC HYBRID BUSES have a 45 degrees sloping (19) front end to minimize the retarding effect of air resistance. At the back of the passengers cabin, on its raised floor, is a private water-closet (20) for the convenience of the passengers during long drives.

FIG. 3(b). The front of the RABBAT INTERURBAN ELECTRIC HYBRID BUS shows the wide panel of the window of the driver's cabin (3) flanked on either side by the electronic cameras (4). Above the front panel of the window lies a strip of powerful LED lights (2) for long beam illumination of the road ahead. Just above the fender is a strip of powerful LED lights (5) with lenses, to illuminate, with a low beam, the short distance directly ahead of the bus. Instead of electric rails as in the URBAN BUS version, the INTERURBAN BUS has a retractable electric plug-line (1) to plug-into the electric grid at stations/terminals in order to recharge the banks of batteries. The front wheels (6) are used to direct the bus while partially supporting the weight. The fenders (7) are made up of horizontally attached pipes.

FIG. 3(c). The rear of the RABBAT INTERURBAN ELECTRIC HYBRID BUS is similar to the URBAN BUS (FIG. 1 (c) version) except that it does not carry any electric rails on top.

FIG. 3(d). This is a cross section showing the rear wheels (1), the chassis platform (2), the passenger cabin floor (3), with raised sides for front facing twin sets of seats (4) and a lowered passage way in-between the seats (5) so as not to have unduly high ceiling for the bus. Between the chassis platform and the cabin floor is a space (6) for batteries and/or luggage. At the back of the passengers compartment is a private water-closet (7).

FIG. 3(e). This is the top-view plan of the RABBAT INTERURBAN ELECTRIC HYBRID BUS. The driver's cubicle (1) has a panel (2) with all the dials controlling the electronic and electric equipment and lighting. It contains closed circuit camera monitors (3) for viewing the surroundings laterally and behind when driving the bus. There are no steps from the driver's cubicle to the passengers cabin passage since the passengers cabin is raised above the luggage compartment. On the right hand side of the driver's cubicle is the heating and air conditioning unit (7). The driver's seat (8) is adjustable. The passengers cabin has twin seats (9) facing forward on either side of the recessed passageway (10). At the rear end of the passageway is a water-closet (11) with a door that can be locked from the inside and pulled closed from the outside. That door can be unlocked from the outside with the driver's master-key. Behind the passengers cabin and above the rear wheels are the generator-module (16) with the generator (13) and the generator motor (15) connected by the axle (14). The door (12) allows for ingress and egress. It has built-in steps (17) and a foldable set of steps (18) that opens out and down to the street level. This set of steps is lifted up and in, atop of the built-in steps, when the door is to be closed.

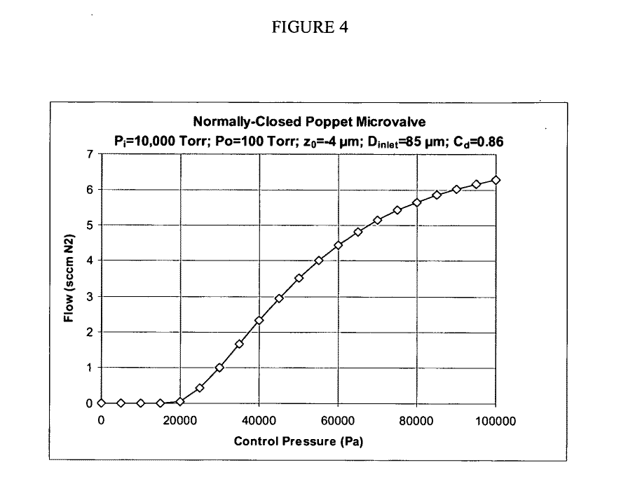

FIG. 4. This figure represents the type of suspension system used in all versions of the RABBAT URBAN/INTERURBAN ELECTRIC HYBRID BUSES. It uses leaf suspensions (1) facing each other and joined at their ends. They are attached at their junction (2) to pneumatic suspensions (3) connected to the chassis platform. A tire-shaped inflated rubber donut acts as a shock-damper between the leaf-suspensions (4).

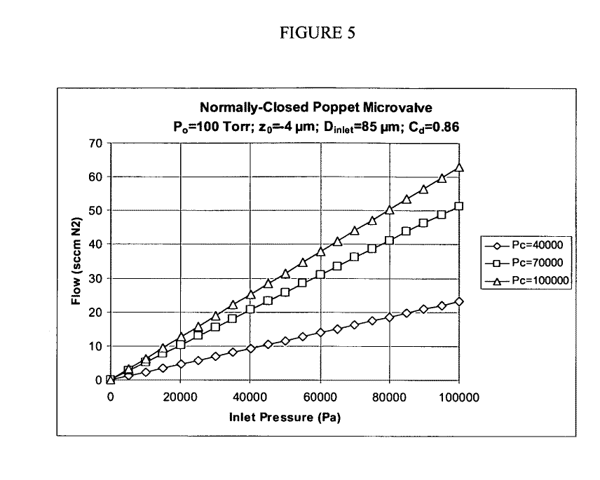

FIG. 5. This is the electric schematic for the RABBAT URBAN, ARTICULATED or INTERURBAN ELECTRIC HYBRID BUSES. (1a) are the electric paired railings, on top of the vehicles, that collect current from the electric dispenser pantograph at the bus-stops for the two types of urban buses. For the interurban bus which does not need the pantograph system of supply, a rewindable electric wire and plug (1b) are available to connect and recharge the capacitors/batteries to the community grid at the station/terminal/The purpose of the whole electric grid is to supply current to the electric drive motors (2) embedded in the drive wheels of the vehicles. One-way directional diodes (3) are interspersed within the schematics to ensure that electricity does not for any reason reverse flow. The hydrocarbon fuelled engine (4) supplies mechanical rotary motion to electric generator (5) via axle (6). This current passes through lines (13) to drive the electric drive motors of the rear wheels (2). Interruptors of electric current (15) serve to disconnect the flow of current to the wheel drive motors (2) whenever necessary. The generator (5) supplies any excess current through line (16) to the banks of batteries (9) which are interspersed with ultra-capacitors (8). When the electric rails (1a) are in contact with an external pantograph, they supply current to the wheel- Drive motors (2) thru line (23). Any excess current is sent to the banks of batteries (9) which are interspersed with ultra-capacitors (8) through line (17). When the windable electric plug (1b) is in contact with an external current grid, it supplies current to the wheel-drive motors (2). Any excess current is sent thru line (24) to the banks of batteries (9) which are interspersed with ultra-capacitors (8). Line (18) supplies current to all distributors and inverters (7) serving all secondary electric or electronic systems. The banks of batteries (9) and ultra-capacitors (8) supply electricity to the wheel-drive motors (2) through line (18). The steering-wheel column (19) directs the vehicle to the right or left. When it is turned right, it disconnects current (20) from wheel-drive motors on the right-side of the vehicle, minimizing speed on that side while speed remains the same on the left side. When the steering wheel is turned left, it disconnects current (21) from wheel-drive motors on the left side of the vehicle, minimizing speed on that side while speed remains the same on the opposite side. The temporary de-activation of current on either side is effected through the appropriate current interrupters (11). It makes turning easier and saves brake-power and brake-lining. Pedal-brakes (10) de-activate current to all wheel-drive motors through current interrupters (11) while hydraulically braking the wheels. Accelerator pedal (14) controls the flow of current to, and consequently the speed of rotation of, the wheels that drive the vehicle.

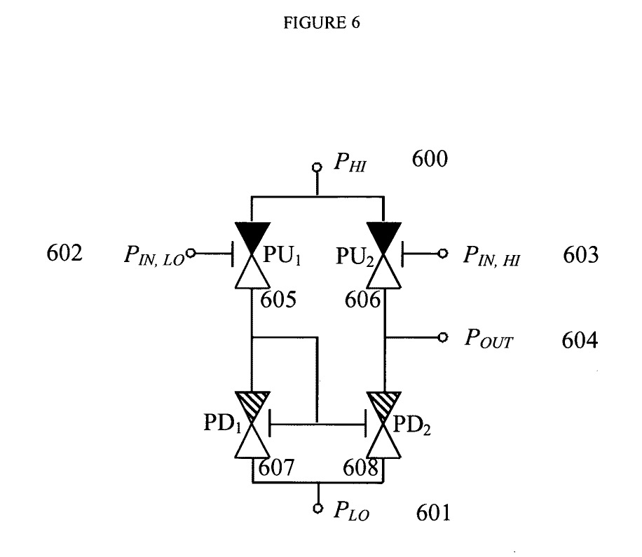

FIG. 6. This is a side view of the floor articulation, showing the rear of the front section (1), overlapping the front of rear section (2). A pin (3) in the lower section fits in a greased upper ring (4) containing ball-bearings.

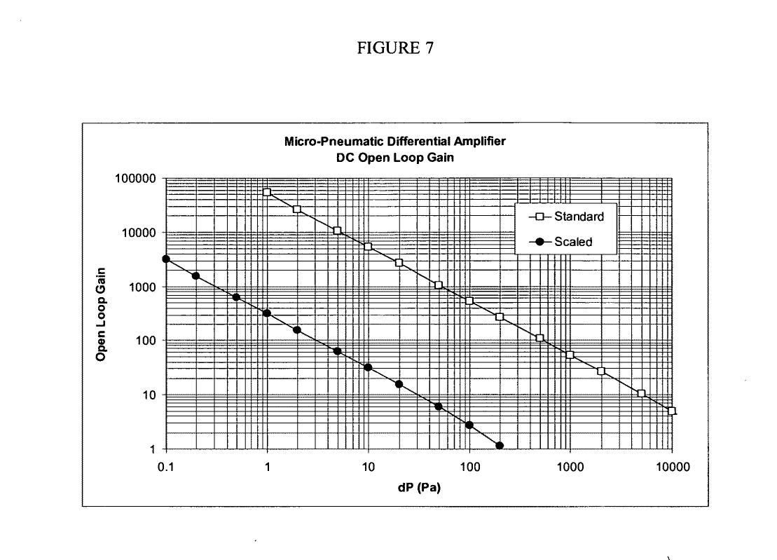

FIG. 7. This is a side view of the pantograph current dispenser. The pantograph dispenser is located at the front corner of each bus-stop. It has a pole (1) that is high enough so that its overhanging arm (2) will reach over the stopped bus, in such a way that its pantograph can make contact with the electric railings on top of the RABBAT URBAN ELECTRIC HYBRID BUS or THE RABBAT ARTICULATED ELECTRIC HYBRID BUS. The pole (1) is in contact with the community electric grid which supplies it with current. The wires carrying that current are embedded within the pole and the extended arm (2). At the end of the overhanging arm is an awning (3) protecting the pantograph and part of the underlying bus top section making contact. The pantograph electric dispenser (4) is made of two similar and parallel sections of opposite electric polarity separated from each other by protective insulation (5) to prevent arcing. Two pantograph rollers (6), conductive of current, make contact with the pair of electric railings on top of the vehicle to dispense current to the vehicle grid, motors(s), capacitors and battery banks. This community electricity serves to recharge the vehicle capacitor/battery system while at the same time supplying energy to the electric generator on board and the wheel-embedded electric motors. It keeps the supply connection when the bus starts to move off from the bus-stop at a time when it needs heavy current to overcome inertia and start the vehicle rolling, until it finally loses contact with the rear edges of the vehicle electric railings. From then on, the vehicle relies on stored energy in its capacitors, its batteries and its hydrocarbon fuel.

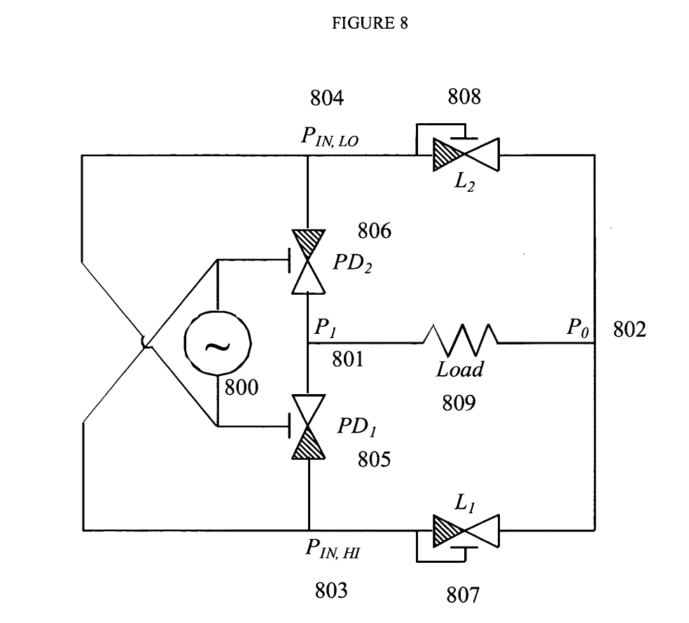

FIG. 8. This is a top view of the RABBAT URBAN ELECTRIC HYBRID BUS STOP. (1) is the entrance point to the bus shelter. A snacks/drinks machine (2) caters to the public and bus customers convenience and provides extra income for the bus line. A token machine (3) sells tokens, tickets or electronic tickets to the potential passengers. Passenger seats (4) are placed around the bus-stop area, folding upward when unoccupied. A partition (5) restricts the passengers egress to line up. The exit is through a conjunction of a door with a one way flap (6) which may permit emergency exit while normal exit is allowed only through the token-operated turnstile (7). Outside the stop-shelter is the pantograph pole for recharging the RABBAT URBAN ELECTRIC HYBRID BUS during its short stop.

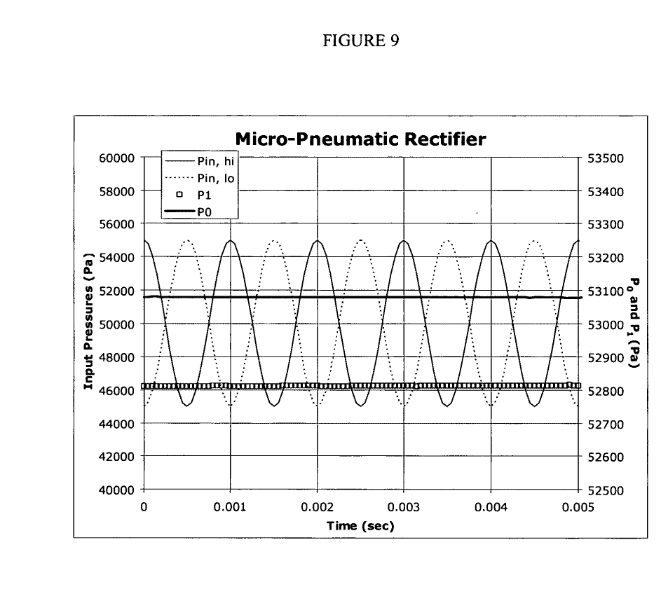

FIG. 9. The air intake of the Rabbat Vehicles Electric generator uses an air-ionizer system. It has a classic air-filter (2) leading to a positive ionizer pole in grid shape (3) leading to a three pronged negative ionizer pole (4), which releases ions into the air stream that penetrates into the engine for the thermal reaction with the hydrocarbon fuel. In another possible version, a stream of oxygen from the electrolysis of water (per patent application by the same inventor in the RABBAT PLUG-IN ENGINE) would enter the air-flow between the two ionizer poles, while the hydrogen from the electrolytic process would enrich the fuel mixture within the engine block proper.

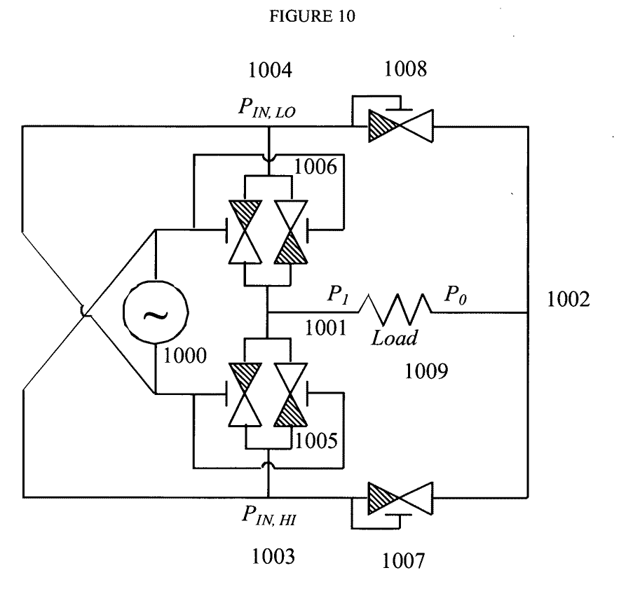

FIG. 10. In the electric storage system essential to the various Rabbat electric hybrid systems, ultra-capacitors play a great role. Unlike electrochemical batteries which take time to convert charge into chemically stored potential current, ultra-capacitors physically store charge in little time and release it quickly either to the slower acting chemical batteries and/or to the vehicle grid for immediate current consumption. These capacitors can be charged immediately during the short bus stops and keep charging the batteries for longer term storage even while the vehicle is on the move away from the pantograph. The form of capacitors and chemical batteries I recommend is elongated rather than cuboid. They are more like large pocket battery dry cells. They may even use advanced cell technologies available. They can thus be made to fit easily into long narrow spaces within the vehicle being interconnected by wiring. It would be commercially advisable to have combined ultra-capacitor/battery units since they are best used together.

FIG. 11. The recommended steering system for the RABBAT ELECTRIC HYBRID is hydraulic. The wheels (1) to be steered are connected by a sturdy arm with a pivot (2). Hydraulic pistons (3) are synchronized to push hydraulic fluid in one piston while releasing fluid from the other, ying-yang style. Hose (4) connects the pistons through appropriate valves. The hydraulic engine compressor (5) is controlled electronically.

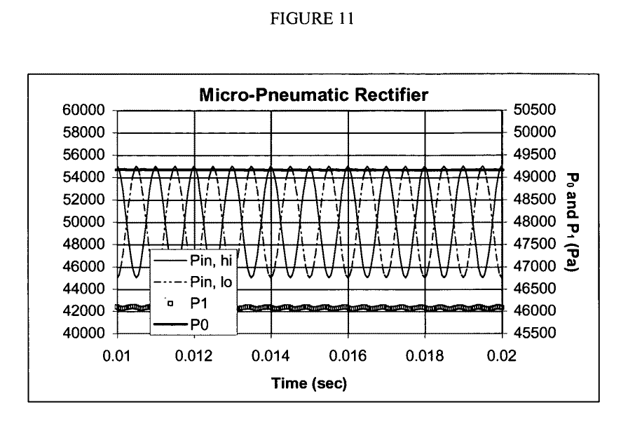

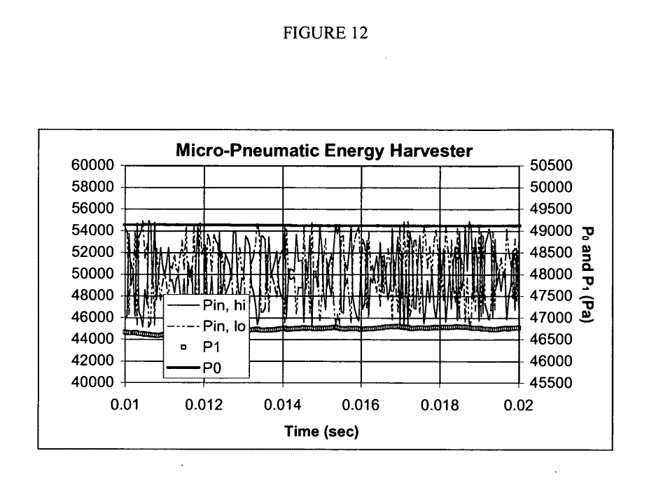

FIG. 12. This is one of the applications of the RABBAT ELECTRIC VEHICLE: the RABBAT ELECTRIC HYBRID SPORTS CAR. This lateral cross-section shows front and rear soft fenders with inflated elongated sausage-shaped rubber dampers (1) which help to absorb some of the potential shocks and return the soft fender, as much as possible, back to its original shape. The front directional wheels (2) are smaller than the rear drive-wheels (3). All tires are non-inflatable as the car relies on triple suspension to provide a gentle ride. (Pls. see FIG. 4). The ultra-capacitor/battery units (4) can be placed around the vehicle according to the design so long as they are connected to each other and to the supply, generator and motor in a suitable manner. In the case of this aerodynamically-shaped sports car where aerodynamics and sleek appearance is necessary for commercialization, these units can make use of the elongated front of the car which does not carry any engine, as a suitable area of low center of gravity. The instrument panel (5) includes closed-circuit cameras for side and rear viewing as well as all electronic controls and meters. A steering wheel (6) controls the hydraulic system. It could take a smaller or even an airplane style incomplete circle steering wheel that will make it look attractively unusual, since very little movement of the steering wheel is enough to activate and control the hydraulics. An electronic joy-stick would also do. The front window (7) is steeply sloped to be as aerodynamic as possible in full streamline with the shape of the car front and the car top. The seats are right above the larger drive-wheels. Their bucket shape agrees well with the bucket-shaped windowless back of the driver's section (8). When the top retractable panel of the car (9) is partly or fully open, the scoop shape will drive wind into the car from the back and top. The top panel sun-roof may be made of some transparent material and may have a sun-ray blocking tint which could even be externally refractive. A locking-hitch (10) connects the tandem section to the driver section physically, electrically and electronically since all controls are in the front and power production is at the back. The tandem section contains the fuel tank (11) and a motor/generator module (12) that can be pulled out for repairs or replacement. A retractable cord (13) for plug-in connection to a public or private source of electric current is available in the rider's section or in any tandem section. The RABBAT ELECTRIC HYBRID SPORTS CAR uses side and back video closed circuit cameras and front panel monitors to view the surroundings instead of mirrors.

This is an artist's rendition of the tandem section for downtown use as attached to the driver's section. It carries a smaller economical engine/generator module and fewer battery/ultra-capacitor units. Its hitch attachment (10) includes a raised or lowered extendable support for free-standing when the tandem section is disconnected for any reason such as for storage, replacement or repair. A larger tandem, as shown may be attached instead for long distance travel. It has a more powerful engine/generator module with more battery/capacitor units. The tandem units, whether free-standing or attached to the driver's section, have retractable cords (13). The center of gravity is as road-hugging as possible so as to provide greater safety and maneuverability. The tank (11) which is on average incompletely full will raise the center of gravity higher but will allow the car a smaller “footprint” when parking downtown than if it were placed lower on a longer tandem. The articulation of the two sections may enable the car to be parked “boomerang” style with an angle at the junction to consequently use less length of parking space. Above the fuel-tank, a rack with retractable belts, or a solid cover (14) is for convenience though on average it is usually not in use. Ventilation flaps (15) on both sides of the engine section will direct air into the engine/generator module and dissipate heat out at the rear. Small donut wheel(s) (2) bear the weight of the tandem and keep it low and road-hugging.

Whenever traveling for a long distance rather than commuting, the more powerful tandem section will be used instead of the commuter tandem. It has a hitch connection (10), an extendable support (16), donut wheel(s) (2). The generator/engine (12) module is more powerful in order to satisfy the need for speed and long-range use. Though this module has vent-flaps (15) it also includes either a fan to dissipate heat or a compressor/heat exchanger to withdraw heat from the engine body to exterior radiator fins. A spacious luggage compartment (17) is available at the rear of the tandem beyond the donut wheel(s). A retractable cord (13)may be extended for recharging capacitor/battery units at stop-points. A wider fender (1) will protect the rear of the RABBAT ELECTRIC HYBRID TANDEM from both low and high fenders on incoming vehicles.

FIG. 13. The RABBAT ARTICULATED HYBRID MINI BUS has three sets of wheels (1) smaller front uninflatable hydraulically directed wheels; (2) larger electric drive wheels with embedded electric motors; (3) small donut wheels to partly bear the weight of the tandem that is connected to the passenger section in front through a hitch (4). The rear seats (5) of the passenger section lie on top of the drive-wheel area with the back seats forming part of the rear-wall. There are no rear windows. Rear viewing is on closed-circuit monitors in the front panel (6). The elongated aerodynamic aesthetic front of the mini-bus contains one or more ultra-capacitor/battery units which are spread around the vehicle keeping the center of gravity low. The other seat rows cover similar units. The front and rear fenders (8) are covered with a soft polymer form aesthetically shaped to cover rubber inflated dampers and sturdy steel fenders. (9) is the luggage compartment with the top half-lifting upward and the lower half downward. The engine/generator (10) module can be pulled out to be replaced in case of mechanical failure or when it is to be discarded for replacement. The fuel tank (11) lies above the engine module feeding it by gravity, suction or injection. The number of seats (12) depends on the price, size and intended purpose of the vehicle.

FIG. 14. The RABBAT ELECTRIC HYBRID VAN is shown in its lateral cross-section. It has two types of wheels (1) small front uninflatable hydraulically directed wheels and sets of similar tandem wheels; (2) rear-drive uninflatable wheels with embedded electric motors. The steering wheel (4) directs a hydraulic control system for the front wheels. It is not necessarily circular but could better be just an arc of a circle or even an electronic joy-stick. Ultra-capacitor/battery units (5) can individually be placed wherever the designer chooses, mainly as low as possible in order that their low-placed weight will keep low the center of gravity of the empty vehicle. If the front section of the RABBAT ELECTRIC HYBRID VAN is elongated per designer's artistic discretion, the low space ahead of the front wheels may be used to contain such units. For vans to be used on long interstate routes, for example, ultra-capacitor/battery units may be placed under the box-section of the van. Such units can easily be disconnected and pulled out or replaced according to the electric storage needs of the usage of the vehicle, in order to decrease the overall deadweight and save on wear and tear of any redundant equipment. An externally sliding two-sided door (6) can manually be opened, individually for personnel entry, or bilaterally for forklift entry. An adjustable seat (7), for the driver and a companion, may cover more electric storage units. The tandem box-car is hitched (8) to the front section. Behind the driver's cabin, the front section has a fuel tank (9) placed above the engine/generator module (10). The size of the tandem section is chosen for practical reasons such as intended use or/and investment costs. The longer the average distance foreseen by the buyer between recharging of electric storage units, the more powerful and consequently more costly an engine/generator he will need to buy. The convenient modularity of the RABBAT ELECTRIC HYBRID VEHICLES offers buyers a configuration adapted and adaptable to their changing needs. The front and rear fenders (11) are covered esthetically with soft polymer over rubber inflated dampers and sturdy steel fenders.

FIG. 15. The RABBAT ELECTRIC HYBRID TRUCK has two types of wheels. Small wheels (1) such as the directional front wheels and the larger sets of drive wheels (2) with embedded electric motors. The engine/generator module (3) is located under the steep sloping front hood. The steep angle of the front part serves to provide unhindered view of the road just in front of the vehicle, for safety and accuracy in parking. The fuel tank (4) is hanging at the back of the driver's cabin. It supplies the forward placed engine/generator through a connecting hose. Below it is the hitch junction (8) connecting the driver's section with the tandem load section. The junction can be separated from the generator section to allow for the use of the driver's section as a personal transport vehicle. It is noteworthy that the majority of small and medium-sized trucks are used, most of the time, as a means of personal transportation in towns and only rarely need their truck-box section. The potential to use the autonomous driver's section with its own rear-drive wheels (2), its own fuel tank (4), its engine/generator (3) and some combined ultra-capacitor/battery units (5) as a personal means of transport that is small and economical, will give this truck an extra economic attractiveness to potential buyers. The steering wheel would preferably take the shape of an arc of a circle or an electronic joy-stick(6). The driver's seat (7) contains another unit of electric storage (5) underneath. The tandem box section (9) has at least two sets of small wheels that can be doubled in case of heavy loading requirements from the purchaser. They provide stability even when the two sections are separated. Below the truck-box more ultra-capacitor/battery are placed to allow for long distance travel with fewer stops for recharge. The box has a lid (10) that can be raised and remain self-supporting. The front slope of the driver's cabin has a recessed rewindable electric plug-in connection (11). The front and rear have soft polymer covering over rubber inflated dampers and sturdy steel fenders (12).

FIG. 16. The RABBAT ELECTRIC HYBRID TRACTOR-TRAILER is made up of two sections or more that are hitched with common trailer connections. The tractor section has a set of small directional wheels (1) which are hydraulically actuated, and a set of large traction-wheels (2). The front windshield is sloping steeply continuing at the same angle as the front of the vehicle. One (or more) set of engine/generator (3) is placed within the front boot above the ultra-capacitor/battery units (5). The fuel tank (4) is at the rear of the driver's cabin hanging above the tractor trailer junction. The steering wheel is arc-shaped or better still has an electronic joy-stick. The driver's seat (7) covers another ultra-capacitor/battery unit. The front section has a receptacle for a rewindable plug-in cord (16). The trailer is basically a low road-hugging bed (9) as is commonly used to transport earth-moving equipment or military tanks. It can be used as such with its own set(s) of low uninflatable wheels (1) and ultra-capacitor/battery units (5). It may also have a cargo-box (10) permanently attached to it, or a removable one. The cargo-box may have an outward sliding door with two leaves (11), one side for personal entry, and both sides for allowing forklifts in. The back of the cargo-box has an up-down rolling lid (12) made up of tubing sliding along side runners. The end of the flatbed (13) can be lifted up to prevent loads or removable containers from falling off. It has like the front of the vehicle, a soft polymer covering (14) over a rubber inflated damper and steel fenders. The end of the flatbed can be lowered and angled to street level to allow for the descent of rolling cargo or unloading materials and equipment. The front and trailer sections have closed-circuit cameras (15) with their monitors being in the driver's cabin. A receptacle (16) with a rewindable cord to plug-into external electric grids is placed in the driver's section.

FIG. 17. The RABBAT ELECTRIC HYBRID TUNNEL TRACTOR is specially built for its low profile to fit into low ceiling mining tunnels, its economic hybrid electric performance, its jointed section which helps it along mining curving tunnels, and its easy reversibility of direction without the need for any turn-around area within the mine-shafts. Having turn-around areas every time the digging gets deeper into the mine is a very serious problem for transport since it is impossible to support the huge area. Such a vehicle will make it unnecessary to build a Decauville rail system for the mine since the vehicle will be able to move deeper within a tunnel and reverse on its axis without making a circle. This vehicle is not meant to replace existing mining systems but, through licensing, each manufacturer in this field of engineering can adapt and improve its newer models without discarding all its previous advantages, experience and reputation. Except for its drive wheels (2), all other wheels (1) are small in size and thus keep the whole train low to the ground since their axles are lower than conventional trucks. Drive wheels (2) are large because they provide traction through their embedded electric motors. All wheels, both (1) and (2) types are uninflatable which allows for even lower vehicle elevation and centre of gravity. Their suspension system combines hydraulic struts, with leaf springs and rubber donut damper wheels in between. There are two driver cabins (13). The driver's seat (7) covers ultra-capacitor/battery units (5) which are spread also at the bottom of the chassis of the tractor section and the box section. In front of one of the driver's cabins could be placed the engine/generator compartment (3) which provides electric power to the vehicle's reversible direction electric motors embedded in the wheels (2). Otherwise an engine/generator could be kept outside the mine tunnel to feed the vehicle's needs through an umbilical overhead cord with the added advantages of the vehicle proper being smaller and exhaust being kept outside the mine. The second cabin is connected to the same drive wheels with a reverse direction switch. In this manner, the vehicle drives into the tunnel, box empty and the engine/generator usually at the back. When it reaches the extreme end of the tunnel where excavation is ongoing, the driver gets out and goes to the rear cabin which now faces the exit and carries the engine (3). When the transporter is loaded, the driver reverses motor direction and pulls out to the open air for delivery. The steering wheel is half-arc (6) because the front facing wheels are hydraulically activated, or more simply the vehicle uses an electronic joystick for direction. Behind the driver's main cabin, hangs the fuel tank (4) unless the engine/generator/fuel tank are outside the mine tunnel. Since the vehicle is flatter than other RABBAT HYBRID ELECTRIC VEHICLES it is more elongated. The rear load section (10) of the vehicle articulates at the hitch (8) which is placed below the fuel tank and above the drive wheels. The chassis of the load section is low to the same level as the chassis of the driver's section. The load hopper (10) does not have any hydraulic lift system for emptying the load. This regression in technology serves to economize on the cost of the vehicle to make it more price competitive. Just as there is equipment within the inside terminal to load, it requires equipment outside the tunnel to unload. It prevents the redundancy and cost of hydraulic arms and compressor in each vehicle of the fleet. The hopper (10) is attached to joints on one side and has hooking rings for lifting by external equipment on the other side. A regular crane can lift the hopper up and empty it sideways.

FIG. 18. The RABBAT WIRED ELECTRIC HYBRID TUNNEL TRACTOR is very much like FIG. 17, except that it does not carry any ultra-capacitors or engine/generator module. It does neither carry any fuel tank. These are located outside the mine shaft and supply electric current to the cheaper vehicle unit through an umbilical electric cord and self-rewinding units (one above the driver's cabin closest to the exit; the other above the generating unit, or the external supply plug-in). If the tunnel curves, the tunnel ceiling will need rods to keep the unwinding cord going around the center of the curve as it swings in the altered direction. Such a cheaper vehicle with a single external generating or supply unit can be useful for a quasi-permanent set-up. Naturally in both types of vehicle there is a fender system (12) on either end with hidden rubber dampers and sturdy steel fenders. It has several small sets of small uninflatable wheels (1), the ones under the driver's cabins can be used to steer the vehicle hydraulically, the remaining ones to spread around the weight of the load so that the roadbed need not be too thick and costly to build, the wheels too costly and hard to build owing to size and probably can be mass produced instead of being crafted one by one. It also has at least two sets of large electric motor-embedded wheels (2) behind and below the the driver's cabin, to provide the traction required. It has one hitch connection (#) right behind one of the driver's cabins to allow for more movement potential around curves. There is a driver's cabin (4) on either end of the vehicle, with at Least one set of motor-embedded un-inflatable wheels depending on the density of the loads expected. Atop the driver's cabin preferably closest to the mine tunnel exit, is a self-rewinding umbilical electric cord (5) which draws out or releases electric line and keeps it taut as the vehicle moves into the tunnel or out of it. The driver makes sure he follows the proper directions around curve ceiling rods to enable the wire to be bent around the rod and not touch the side of the tunnel. Each cabin has only one seat for the driver (6) and a steering wheel either shaped like an arc of a circle (7) or an electronic joy-stick to control the hydraulically activated directional wheels. There may be several units of small un-inflatable wheels (1) supporting the weight of the load section; their number varies according to the density of the loads to be expected. They are small sized in order to keep the center of gravity of the load as low as possible for obvious turning advantage and in order to maximize the height, and consequently the content of the load. Complex suspensions (8) including hydraulic struts, leaf suspensions and inflated rubber donuts as used in other RABBAT ELECTRIC HYBRID VEHICLES to render the vehicle's movement as even as possible. This vehicle does not need to carry either an engine/generator, or a fuel tank, or any capacitor/battery units since it is in wired connection with the external generator or electric plug-in. The chassis of the load section is lower than that in FIG. 17 which would result either in extra weight lift or in a shorter load hopper, while keeping to the same height within the tunnel. The drive wheels (2) are located beneath the driver's cabin, providing traction that is reversible in direction without increasing the height of the vehicle. The load section is articulated at the hitch (3) right behind the driver's cabins. The load hopper (9) does not include any hydraulic lifting mechanism for emptying. It relies on external means of lifting the hopper through hooking rings on one side while the other side is hinged in order to effect unloading on one side only.

FIG. 20. The RABBAT ELECTRIC HYBRID SCOOTER is made up of two sections connected by a junction (4) that allows the front part to turn right or left. This scooter has a small un-inflatable wheel (1) which is turned by moving the built-in handle bars(12). The rotating cylindrical or elliptical body (13) turns around axis (4). (13) contains the engine/generator module which receives fuel from the fuel tank (7) and produces electricity to a set of ultra-capacitors/batteries hidden under the seats (9). The plug-in cord (6) is connected to these ultra-capacitors/batteries to regenerate them from some external electricity source. The top of (13) contains all necessary dials and switches (10) and a front facing strip of powerful LED lights and side LED signals. The rear of the scooter has LED lights, brake lights and signals (10). Fenders (8) at the rear and front (not shown) have a shock-absorbing core covered by a soft polymer cover to minimize collision forces. The large rear wheel(s) (2) are un-inflatable and contain an electric motor embedded for traction. Pedals (5) control the electric drive motor in (2): the right side feeds electricity and is used for acceleration while the left pedal disconnects current, applies brakes and lights brake signals. While the driver's feet are on the front platform and pedals (5), the passenger's feet rest on (3).

FIG. 21. The RABBAT ELECTRIC HYBRID RICKSHAW has a small un-inflatable front wheel (1) which is turned around to right or left by built-in handle-bars (12). The rotating cylindrical or elliptical body (13) turns around axis junction (4) connecting the front section of the rickshaw with the rear. (13) contains the engine/generator which receives fuel from the fuel tank (7) and feeds electricity to a set of ultra-capacitors/batteries hidden under the seats (9). The plug-in cord (6) is connected to these ultra-capacitors/batteries to regenerate them from external sources of power. The top of (13) contains all necessary dials and switches (10) and a front-facing strip of LED lights and side LED signals. The rear of the rickshaw has LED lights, brake lights and signals. Fenders (8) at the rear and front (which is not shown here) minimize collision forces. The large rear wheels (2) have an electric motor embedded in each for traction. Pedals (5) control the electric drive motors in (2): the right side feeds electricity and produces acceleration while the left pedal disconnects current and applies brakes and turns on brake signals. The driver's feet rest on the forward platform and uses pedals (5). The folding sectional hardtop (14) protects both driver and passengers from sun or rain. It is rotated forward to allow entry of passengers into their compartment, to go up steps (3) and sit on bench seat (9). The top (14) may be partially or completely retracted backward during beautiful weather.

What we claim:

1. A valve, comprising:
a flow passage;
a working fluid;
an inlet pressure at one end of said flow passage;
an outlet pressure at the opposite side of said flow passage;
a control pressure;
a difference pressure, defined between said control pressure and either said inlet pressure or said outlet pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
and wherein said valve is deployed in a fluidic circuit for processing analog pressure signals.

2. The valve of claim 1, wherein said flow passage is a flow channel.

3. The valve of claim 1, wherein said flow passage is an orifice plate.

4. The valve of claim 3, wherein said difference pressure is defined by the difference between said control pressure and said outlet pressure.

5. The valve of claim 4, wherein said threshold pressure is greater than zero.

6. The valve of claim 3, wherein said difference pressure is defined by the difference between said inlet pressure and said control pressure.

7. The valve of claim 6, wherein said threshold pressure is greater than zero.

8. The valve of claim 1, wherein said pre-tensioned member is a membrane.

9. The valve of claim 8, wherein said occluding component is a boss, and wherein said membrane is attached to said orifice plate such that the thickness of said boss effects the pre-tensioning of said membrane.

10. The valve of claim 8, wherein said occluding component is a poppet structure, and wherein said membrane is attached to said orifice plate such that the height of said poppet structure effects the pre-tensioning of said membrane.

11. The valve of claim 1, wherein said fluidic circuit is a differential pressure signal amplifier.

12. The valve of claim 1, wherein said fluidic circuit is a sinusoidal pressure signal rectifier.

13. The valve of claim 1, wherein said fluidic circuit is a pressure-based mass pump.

14. The valve of claim 1, wherein said fluidic circuit is a fluidic energy harvester.

15. A symmetric pass gate for fluidic signal processing, comprising:
a working fluid;
an inlet pressure;
an outlet pressure;
a control pressure;
a pass gate pressure difference, defined between said inlet pressure and said outlet pressure;
a first valve, comprising:
a flow passage;
an inlet pressure at one end of said flow passage;
an outlet pressure at the opposite side of said flow passage;
a control pressure;
a difference pressure, defined between said control pressure and said outlet pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
and, a second valve, identical to said first valve;
wherein said inlet pressure of said pass gate is coupled to said inlet pressure of said first valve, and to said outlet pressure of said second valve;
wherein said outlet pressure of said pass gate is coupled to said outlet pressure of said first valve, and to said inlet pressure of said second valve;
wherein said control pressure of said pass gate is coupled to said control pressure of said first valve, and to said control pressure of said second valve;
and wherein said working fluid is transmitted equally through said pass gate, whether the sign of said pass gate pressure difference is positive or negative, when said control pressure of said pass gate causes said difference pressure for either said first or second valve to exceed said threshold pressure.

16. A symmetric pass gate for fluidic signal processing, comprising:
a working fluid;
an inlet pressure;
an outlet pressure;
a control pressure;
a pass gate pressure difference, defined between said inlet pressure and said outlet pressure;
a first valve, comprising:
a flow passage;
an inlet pressure at one end of said flow passage;
an outlet pressure at the opposite side of said flow passage;
a control pressure;
a difference pressure, defined between said inlet pressure and said control pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
and, a second valve, identical to said first valve;
wherein said inlet pressure of said pass gate is coupled to said inlet pressure of said first valve, and to said outlet pressure of said second valve;
wherein said outlet pressure of said pass gate is coupled to said outlet pressure of said first valve, and to said inlet pressure of said second valve;
wherein said control pressure of said pass gate is coupled to said control pressure of said first valve, and to said control pressure of said second valve;
and wherein said working fluid is transmitted equally through said pass gate, whether the sign of said pass gate pressure difference is positive or negative, when said control pressure of said pass gate causes said difference pressure for either said first or second valve to exceed said threshold pressure.

17. A differential pressure signal amplifier, comprising:
a working fluid;
a high supply pressure;
a low supply pressure;
a high signal input pressure;
a low signal input pressure;
a signal output pressure;
a differential input pressure, defined between said high signal input pressure and said low signal input pressure;
a first valve, comprising:
a flow passage;
an inlet pressure at one end of said flow passage;
an outlet pressure at the opposite side of said flow passage;
a control pressure;
a difference pressure, defined between said inlet pressure and said control pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
a second valve, identical to said first valve;
a third valve, comprising:
a flow passage;
an inlet pressure at one end of said flow passage;
an outlet pressure at the opposite side of said flow passage;
a control pressure;
a difference pressure, defined between said control pressure and said outlet pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
a fourth valve, identical to said third valve;
wherein said inlet pressure of said first valve is coupled to said high supply pressure;
wherein said control pressure of said first valve is coupled to said low signal input pressure;
wherein said outlet pressure of said first valve is coupled to said inlet pressure of said third valve, said control pressure of said third valve, and said control pressure of said fourth valve;
wherein said inlet pressure of said second valve is coupled to said high supply pressure;
wherein said control pressure of said second valve is coupled to said high signal input pressure;
wherein said outlet pressure of said second valve is coupled to said inlet pressure of said fourth valve, and said signal output pressure;
wherein said outlet pressure of said third valve is coupled to said low supply pressure;
wherein said outlet pressure of said fourth valve is coupled to said low supply pressure;
and, wherein said signal output pressure is an amplified function of said differential input pressure.

18. A fluidic signal rectifier, comprising:
a working fluid;
a time-dependent pressure source, comprising:
a source high pressure;
a source low pressure;
and, means to vary the difference between said source high pressure and said source low pressure as a function of time;
a load high pressure;
a load low pressure;
a first pass gate, comprising:
an inlet pressure;
an outlet pressure;
and a control pressure;
wherein the pass gate enables flow when the control pressure exceeds a threshold pressure;
a second pass gate, identical to said first pass gate;
a first load valve, comprising:
a flow passage;
an inlet pressure at one end of said flow passage;
an outlet pressure at the opposite side of said flow passage;
a control pressure;
a difference pressure, defined between said control pressure and said outlet pressure;
and a pre-tensioned member, comprising:
a movable component;
a pre-tension applied to said movable component;
and an occluding component;
wherein said inlet pressure, said outlet pressure, and said control pressure are delivered by said working fluid;
and wherein said working fluid has the same thermodynamic phase throughout said valve;
and wherein said pre-tensioned member normally occludes said orifice plate flow passage, until said difference pressure exceeds a threshold pressure;
a second load valve, identical to said first load valve;
wherein said source high pressure is connected to said inlet pressure of said first pass gate, and to said inlet pressure of said first load valve, and to said control pressure of said first load valve, and to said control pressure of said second pass gate;
and wherein said source low pressure is connected to said inlet pressure of said second pass gate, and to said inlet pressure of said second load valve, and to said control pressure of said second load valve, and to said control pressure of said first pass gate;
and wherein said outlet pressure of said first pass gate is connected to said outlet pressure of said second pass gate;
and wherein said outlet pressure of said first load valve is connected to said outlet pressure of said second load valve;
and wherein said connection between said first and second pass gates is contiguous with said load low pressure;
and wherein said connection between said first and second load valves is contiguous with said load high pressure;
and wherein the difference between said load high pressure and said load low pressure is relatively independent of time.

19. The fluidic signal rectifier of claim 18, wherein the difference between said load high pressure and said load low pressure may be coupled across an arbitrary load in order to extract useful work.

20. The fluidic signal rectifier of claim 18, wherein said first and second pass gates are fully-symmetric pass gates.

21. The fluidic signal rectifier of claim 18, wherein said time-dependent pressure source varies sinusoidally with time, thereby constituting a pressure-based mass pump.

22. The fluidic signal rectifier of claim 18, wherein said time-dependent pressure source varies randomly with time, and wherein said working fluid is a compressible gas, thereby constituting a pneumatic energy harvester.

23. The fluidic signal rectifier of claim 18, wherein said time-dependent pressure source varies randomly with time, and wherein said working fluid is an incompressible fluid, thereby constituting a hydraulic energy harvester.
